(19) United States
(12) Patent Application Publication
(10) Pub. No.: US 2022/0311508 A1
(43) Pub. Date: Sep. 29, 2022

(54) COMMUNICATION SYSTEM WITH SATELLITE INTERFACE MECHANISM AND METHOD OF OPERATION THEREOF

(71) Applicant: M2SL Corporation, Fort Lee, NJ (US)

(72) Inventor: Syngbum Kim, Fort Lee, NJ (US)

(21) Appl. No.: 17/704,556

(22) Filed: Mar. 25, 2022

Related U.S. Application Data
(60) Provisional application No. 63/167,574, filed on Mar. 29, 2021.

(51) Int. Cl. H04B 7/185

(52) U.S. Cl. CPC H04B 7/18528

(57) ABSTRACT

A communication system comprising: a satellite interface unit including: a tracking antenna configured to process a down-link satellite packet and an up-link satellite packet, wherein the tracking antenna includes a parasitic layer and a waveguide interposer, a satellite communication circuit, coupled to the tracking antenna, configured to amplify the down-link satellite packet and the up-link satellite packet, a storage device, coupled to the satellite communication circuit, configured to store satellite data processed by the satellite communication circuit, and an interface module, coupled to the storage device, configured to exchange the satellite data as a cellular communication packet, a WiFi packet, or a combination thereof when a local infrastructure is non-accessible.

### CROSS REFERENCE TO RELATED APPLICATION(S)

This application claims the benefit of U.S. Provisional Patent Application Ser. No. 63/167,574 filed Mar. 29, 2021, and the subject matter thereof is incorporated by reference herein.

### TECHNICAL FIELD

An embodiment of the present invention relates generally to a communication system, and more particularly to a system for communication via satellite interface.

### BACKGROUND

A user terminal is the device that is used by an end user to access the services provided by the wireless network. In satellite communication, user terminal plays a key role in establishing and maintaining satellite connections. Conventional satellite communication provides a connection between Geostationary Earth Orbit (GEO) satellite positioned over the Equator and mobile users on the ground. The distance between GEO satellite and user can be up to 35,786 km, so that there can be more than 500 milli-seconds of communication delay.

Additionally, transmitting and receiving satellite signals over that distance can require high power for communication. Nowadays, the satellite communication with Low-Earth Orbit (LEO) satellite is increasing. The LEO satellite communication has advantages of low latency, short revisit interval, and dense coverage with many small satellites available for communication. Although a LEO satellite is located at lower altitude (160 to 2,000 km), the free space path loss can be near 170 dB, making signal processing very difficult.

Thus, a need still remains for a communication system with satellite interface mechanism to enable Internet and cellular communication on a world-wide basis. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an apparatus, including a communication system, including: a tracking antenna configured to process a down-link satellite packet and an up-link satellite packet, wherein the tracking antenna includes a parasitic layer and a waveguide interposer, a satellite communication circuit, coupled to the tracking antenna, configured to amplify the down-link satellite packet and the up-link satellite packet, a storage device, coupled to the satellite communication circuit, configured to store satellite data processed by the satellite communication circuit, and an interface module, coupled to the storage device, configured to exchange the satellite data as a cellular communication packet, a WiFi packet, or a combination thereof when a local infrastructure is non-accessible.

An embodiment of the present invention provides a method including: processing a down-link satellite packet and an up-link satellite packet through a parasitic layer and a waveguide interposer of a tracking antenna; amplifying the down-link satellite packet and the up-link satellite packet; storing satellite data processed by a satellite communication circuit; and exchanging the satellite data as a cellular communication packet, a WiFi packet, or a combination thereof when a local infrastructure is non-accessible.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an example of a functional block diagram of a communication system with portable interface mechanism in an embodiment of the present invention.

FIG. 2 is an example of an exploded view of a panel of the tracking antenna of FIG. 1 in an embodiment.

FIG. 3 is an example of an exploded view of a Cassegrain dish tracking antenna in an embodiment of the present invention.

FIG. 4 is an example of a functional block diagram of the satellite interface unit in an embodiment of the present invention.

FIG. 5 is an architectural block diagram of the communication system in an embodiment of the present invention.

FIG. 6 is an architectural block diagram of a low noise block down converter (LNB) in an embodiment of the present invention.

FIG. 7 is an architectural block diagram of a block up converter (BUC) in an embodiment of the present invention.

FIG. 8 is a flow chart of a method of operation of a communication system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

As an example, satellites in low-Earth orbit (LEO) can be at an altitude of between 160 to 2,000 km (99 to 1200 mi) above the Earth's surface. A satellite below this altitude can suffer from orbital decay leading to a rapid descent into the atmosphere, either burning up or crashing on the surface. Satellites at this altitude also have an orbital period (i.e. the time it will take them to orbit the Earth once) of between 88 and 127 minutes. A geosynchronous orbit is a high Earth orbit that allows satellites to match Earth's rotation. Located at 22,236 miles (35,786 kilometers) above Earth's equator, this position is a valuable spot for monitoring weather, communications and surveillance, but presents a prohibitively high latency, that can be greater than 500 milli-seconds, in a communication exchange.

As an example, three parameters can be manipulated in order to optimize the capacity of a communications link—bandwidth, signal power and channel noise. An increase in the transmit power level results in an increase of the communication link throughput, likewise a decrease in power will result in the opposite effect reducing the throughput. Also, for example, another way to improve the link throughput would be to increase the size of the receiving antenna in order to have a higher level of energy received at a receiver. But this is where operational constraints become apparent, as, an increase in the size of the receiving antenna could lead to an unfeasible installation for a personal or business application due to the real estate required and the installation cost.

User terminal systems can provide access to the LEO satellite systems utilizing mobile antennas and electronic packages. The antenna can receive the downlink signal or beacon from satellite and transmits the uplink signal to the satellite. The antenna needs very sensitive components and low noise amplifier blocks to amplify the satellite signal without inducing noise related erroneous data to the stream. The conversion system and components can be selected according to the communication protocol and system parameters to support the satellite specification and local interface demands.

The term “module” referred to herein can include specialized hardware supported by software in an embodiment of the present invention in accordance with the context in which the term is used. For example, the software can be machine code, firmware, embedded code, and application software. Also, for example, the specialized hardware can be circuitry, processor, computer, integrated circuit, integrated circuit cores, analog components, phase-lock loops, a pressure sensor, an inertial sensor, a microelectromechanical system (MEMS), passive devices, or a combination thereof. The analog components can include inductors, capacitors, resistors, transistors, varactors, and oscillators. The term “abut” referred to herein is defined as two components in direct contact with each other with no intervening elements. The term “couple” referred to herein is defined as multiple elements linked together by wired or wireless means. The term “unit” referred to herein is defined to be a hardware structure constructed to achieve specific signal processing goals. The term “local infrastructure” referred to herein is defined as cell towers, networking apparatus, repeaters, or a combination thereof used for cellular communication. The term “non-accessible” referred to herein is defined as unable to be accessed due to equipment failure, weak signals, power loss, accidents, natural disaster, or sabotage. The term “selectively communicate with a satellite” referred to herein is defined as picking one of an array of satellites available on the horizon with which to exchange information. As a satellite passes from view, another satellite of the array of satellites available on the horizon can be selected as the communication target.

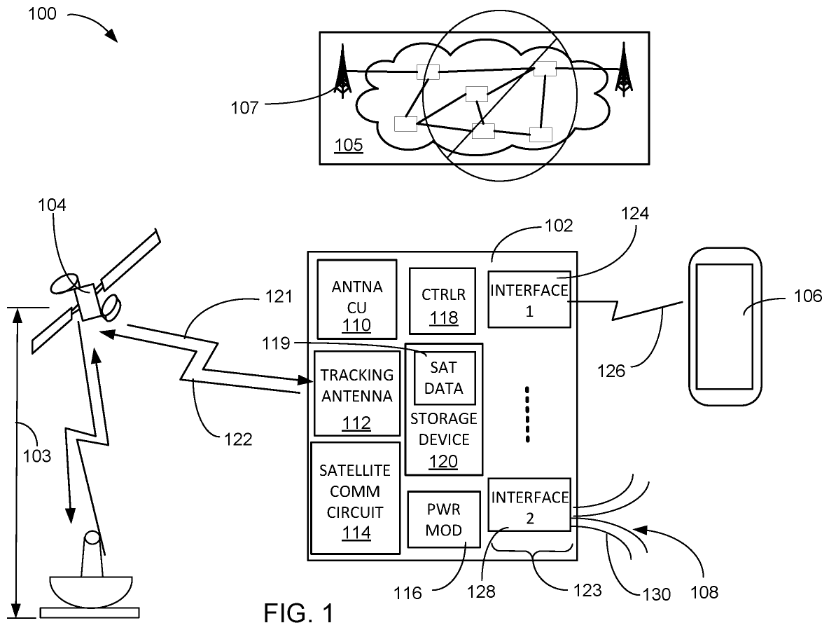

Referring now to FIG. 1, therein is shown an example of a functional block diagram of a communication system 100 with portable interface mechanism in an embodiment of the present invention. The communication system 100 is depicted in FIG. 1 as a functional block diagram of the communication system 100 with a satellite interface unit 102.

The satellite interface unit 102 can be an integrated hardware structure, capable of accessing a low-Earth orbit (LEO) 103, that can couple to a satellite 104 to provide communication. As an example, the satellite interface unit 102 can provide communication in a region whether a local infrastructure 105 is non-accessible, unavailable, or disabled due to damage or loss of power. The local infrastructure 105 can be the communication support network in a local area, including wired and wireless networks, cell phone towers, repeaters, or routers used for delivery of emergency communication services, mobile phone service, Internet services, or a combination thereof.

The satellite interface unit 102 can provide support for the satellite 104 in the low-Earth orbit (LEO) 103, at an approximate altitude of between 160 to 2,000 km (99 to 1200 mi) above the Earth's surface, or geosynchronous Earth orbit (GEO), which is a high Earth orbit located at 22,236 miles (35,786 kilometers) above Earth's equator, that allows satellites to match Earth's rotation. As an example, the satellite 104 can transmit, receive, or a combination thereof a Ka-band signal in a defined frequency range of 26.0 to 40.0 GHz as well as the Ku-band signal in a defined frequency range of 12.0 to 18.0 GHz. The satellite interface unit 102 can be configured to support other orbit altitudes and frequency spectrums.

The satellite interface unit 102 can provide a communication link between the satellite 104 and a communication device 106 including as examples mobile devices supporting third generation telecommunication (3G), long term evolution (LTE), fourth generation telecommunication (4G), fifth generation telecommunication (5G), or a combination thereof. The satellite interface unit 102 can also provide a communication link between the satellite 104 and act as a wireless fidelity application (WiFi) hotspot 108. The WiFi hotspot 108 can include support for computers, laptops, tablets that access a local area network (LAN), a wide area network (WAN), a Fiber-Channel token ring (FC), or a combination thereof. The satellite interface unit 102 can also provide a communication link between one or more of the satellite 104 and the communication device 106.

The communication system 100 can include an antenna control unit 110 to analyze and track the satellite signals and beacon signals transmitted from the satellite 104 in the low-Earth orbit (LEO) 103. The antenna control unit 110 can assist in switching between multiple of the satellite 104 that move into or out of range of the communication system 100. The antenna control unit 110 can control a tracking antenna 112 that provides the ability to maintain communication with the satellite 104 as it moves through the field of view of the communication system 100. The tracking antenna 112 can be a steerable beam phase array antenna or a Cassegrain parabolic dish antenna capable of sending and receiving signals in the Ka-band frequency spectrum and the Ku-band frequency spectrum and maintaining a position track of the satellite 104. The construction of the tracking antenna 112 can provide tracking and communication for the satellite 104 in the low-Earth orbit 103. The antenna control unit 110 can enable or disable paths within the tracking antenna 112 that can selectively transmit and receive down-link satellite packets 121 and up-link satellite packets 122 to specific ones of the satellite 104. The down-link satellite packets 121 can include a tracking beacon including the identification of the satellite 104 and phase information used for tracking the movement of the satellite, as well as the satellite data 119. The antenna control unit 110 can also maintain a position track of the satellite 104 by electronically altering the effective position of the tracking antenna 112 by phase manipulation or physical movement of the tracking antenna 112. The antenna control unit 110 can include a processor and support electronics to provide the tracking of the satellite 104.

By way of an example, in a disaster situation, the satellite interface unit 102 can provide basic and advanced communication services for anyone attempting to communicate without the use of the local infrastructure 105. The satellite interface unit 102 can be configured to support other interface structures (not shown), including Bluetooth, Near Field Communication, laser communication, fiber optics, or a combination thereof.

The satellite interface unit 102 can include the tracking antenna 112 coupled to a satellite communication circuit 114 configured to communicate with the satellite 104 orbiting the Earth in the LEO 103 position. As an example, the tracking antenna 112 can be configured to support frequencies in a Ku frequency band, in the range of 13.4 GHz through 14.9 GHz, in a Ka frequency band, in the range of 27.5 GHz through 32.5 GHz, in a 5G frequency band, targeted for 15 GHz or 28 GHz, or a combination thereof. It is understood that other frequency ranges can be supported in both higher frequency and lower frequencies. The tracking antenna 112 can be a parasitic patch layer adhered to a feed horn array coupled to a waveguide interposer and a waveguide interface for communicating with the satellite communication circuit 114.

A power module 116 can provide independent power to operate the satellite interface unit 102 and provide auxiliary power for the communication device 106. The power module 116 can include batteries, solar power, a generator interface, wind mill power, or a combination thereof. The power module 116 can include any sustainable power source that will provide sufficient energy to enable the communication through the satellite interface unit 102.

The satellite interface unit 102 can also include a unit controller 118 configured to manage the operations of the satellite interface unit 102 including managing a satellite data 119. The unit controller 118 can be implemented as a processor, a micro-computer, a microprocessor core, an application specific integrated circuit (ASIC) an embedded processor, a microprocessor, a hardware control logic, a hardware finite state machine (FSM), a digital signal processor (DSP), or a combination thereof. The satellite data 119 can be the payload from the down-link satellite packets 121 or the preparation data for encoding the up-link satellite packets 122. The unit controller 118 can access a storage device 120 that can provide a data storage function for receiving and reformatting the down-link satellite packets 121 of the satellite data 119 for transfer to the communication device 106 or the WiFi hotspot 108. The unit controller 118 can access the storage device 120 that can provide a data storage function for assembling the satellite data 119 requests from the communication device 106 and the WiFi hotspot 108 that can be submitted to the satellite communication circuit 114 to generate the up-link satellite packets 122.

The storage device 120 can include a hard disk drive (HDD), a solid-state storage device (SSD), non-volatile memory, volatile memory, or a combination thereof. The physical capacity of the storage device 120 can be configured based on the number and type of interface modules 123 that are to be activated by the satellite interface unit 102.

By way of an example, the satellite interface unit 102 can be configured with a first interface module 124 that can provide cellular communication packets 126 to the communication device 106, a second interface module 128 that can provide the WiFi hotspot 108 for the communication device 106 or act as the WiFi hotspot 108 for additional computers within a 1 kilometer range of the satellite interface unit 102. It is understood that other types of the interface modules 123 can be installed in the satellite interface unit 102 in order to address the communication needs of a region (not shown) that has the local infrastructure 105 non-accessible or disabled due to damage or loss of power.

It is understood that the satellite interface unit 102 can provide needed satellite communication options, when the local infrastructure 105 cannot support the communication requirement for the region. The lack of availability of the local infrastructure could be caused by natural disaster, man-made or naturally occurring power loss, damage to cell towers 107, or communication traffic overload due to some calamity. The satellite interface unit 102 can provide a configurable communication interface for mobile applications, including police and fire department vehicles, private vehicles, military, commercial, and private water vessels, military, commercial, or private aircraft.

The satellite interface unit 102 can provide multiple communication types in an off-the-grid environment. Many remote locations rely on the satellite 104 for basic communication and Internet services. The satellite interface unit 102 can include the antenna control unit 110 for tracking and switching between multiple of the satellite 104. The communication system 100 can be used in multiple environments including an automobile, a train, a motorcycle, an airplane, a boat, a bicycle, or the like. The communication system 100 of the present invention can quickly provide a communication infrastructure for multiple users in regions where the local infrastructure 105 is non-accessible due to lack of power or natural disasters have disabled any of the local infrastructure 105 that may have been present.

It has been discovered that the communication system 100 can convert the satellite data 119 to provide the cellular communication packets 126 and WiFi packets 130 for the communication device 106, the WiFi hotspot 108, or a combination thereof whether or not the local infrastructure 105 is non-accessible, disabled, or missing completely. Since the satellite interface unit 102 can be configured for communicating with specific ones of the satellite 104 and provide multiple of the interface modules 123 to address communication issues that previously required a base station the size of a house that cannot be transported or quickly configured to address outages that can befall a region. It is understood that the frequencies of the cellular communication packets 126, the WiFi packets 130, the down-link satellite packets 121, the up-link satellite packets 122 can provide support for hundreds of users of the cell phone 106 and the WiFi hotspot 108.

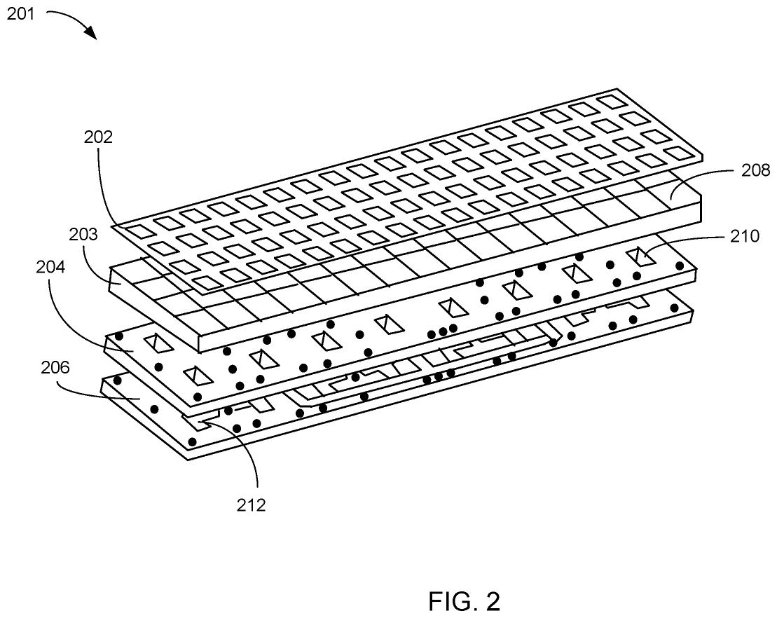

Referring now to FIG. 2, therein is shown an exploded view of a panel 201 of the tracking antenna 112 of FIG. 1 in an embodiment. The tracking antenna 112 can be a steerable beam phase array antenna formed by joining multiple of the panel 201, which include a parasitic patch layer 202, a feed horn array 203, a waveguide interposer 204 and a waveguide interface board 206 that can direct the frequencies of the down-link satellite packets 121 of FIG. 1 to the satellite communication circuit 114 of FIG. 1.

By way of an example, the parasitic patch layer 202 can be a thin film layer adhered to the feed horn array 203. The parasitic patch layer 202 can be the thin film layer patterned with a conductive layer configured to allow directional adjustments to the down-link satellite packets 121 received from the satellite 104 of FIG. 1 and the up-link satellite packets 122 transmitted to the satellite 104. Continuing with the Example, the feed horn array 203 is shown having a four by 16 configuration. Each feed horn 208 can be configured to operate with three of the adjacent ones of the feed horn 208 to steer the down-link satellite packets 121 into the waveguide interposer 204. The embodiment of the panel 201 of the tracking antenna 112 is suitable for communication with the satellite 104 of FIG. 1 in the low-Earth orbit (LEO) 103 of FIG. 1 and using a Ka frequency spectrum in the range of 18.8 to 19.3 GHz down-link and 27.5 to 28.35 GHz up-link or the Ku frequency spectrum in the range of 10.7 to 12.7 GHz down-link and 14.0 to 14.5 GHz up-link.

The waveguide interposer 204 can abut the feed horn array 203. A tight seal between the waveguide interposer 204 and the feed horn array 203 can provide a low impedance path for the down-link satellite packets 121 at a received frequency in the Ka band specified as a frequency range of 18.8 GHz to 27.5 GHz. In a further embodiment the tracking antenna 112 can also transmit the up-link satellite packets 122 and receive the down-link satellite packets 121 from a specific one of the satellite 104 in the low Earth orbit (LEO) 103. In this example, the tracking antenna 112 used to support the satellite 104 operating in the Ku frequency spectrum in the range of 10.7 to 12.7 GHz downlink and 14.0 to 14.5 GHz uplink.

The waveguide interposer 204 can have a waveguide opening 210 that is specific to the frequency used to communicate with the satellite 104. The waveguide opening 210 for the satellite 104 configured in the LEO 103 can have a dimension of 19.05 mm by 9.525 mm of the rectangular shape of the waveguide openings 210. The waveguide opening is oriented so that four of the feed horn 208 are aligned with the input of the waveguide opening 210. This also allows the tracking antenna 112 to use electronic tracking of the satellite 104.

The waveguide interface board 206 can abut the waveguide interposer 204, opposite the feed horn array 203. The waveguide interface board 206 can have a rectangular waveguide 212 formed on the surface that abuts the waveguide interposer 204. the openings of the rectangular waveguide 212 are aligned with the waveguide openings 210 of the waveguide interposer 204, forming an impedance matched structure that can pass the down-link satellite packets 121 with a gain of 30.0 dBi for the receiver in the LEO 103 configuration and a gain of 31.0 dBi for the transmitter of the tracking antenna 112.

It has been discovered that multi-layer structure of the tracking antenna 112 can improve gain of the antenna structure is assembled by joining the parasitic layer 202, the feed horn array 203, the waveguide interposer 204, and the waveguide interface board 206. By matching the impedance of the combined structure, the tracking antenna 112 can boost the overall gain of the tracking antenna 112 by 1 to 3 dB. In addition, the voltage standing wave ratio (VSWR) of the antenna is less than 2:1, and the return loss is also lower than −10 dB. Because the structure requires the up-link satellite packet 122 and the down-link satellite packets 121 to make a 90-degree turn between the waveguide interposer 204 and the waveguide interface board 206, a bulge structure was added to the waveguide interface board 206 to reduce the reactance of the circuit and optimized the transmission of the up-link satellite packet 122 and the down-link satellite packets 121.

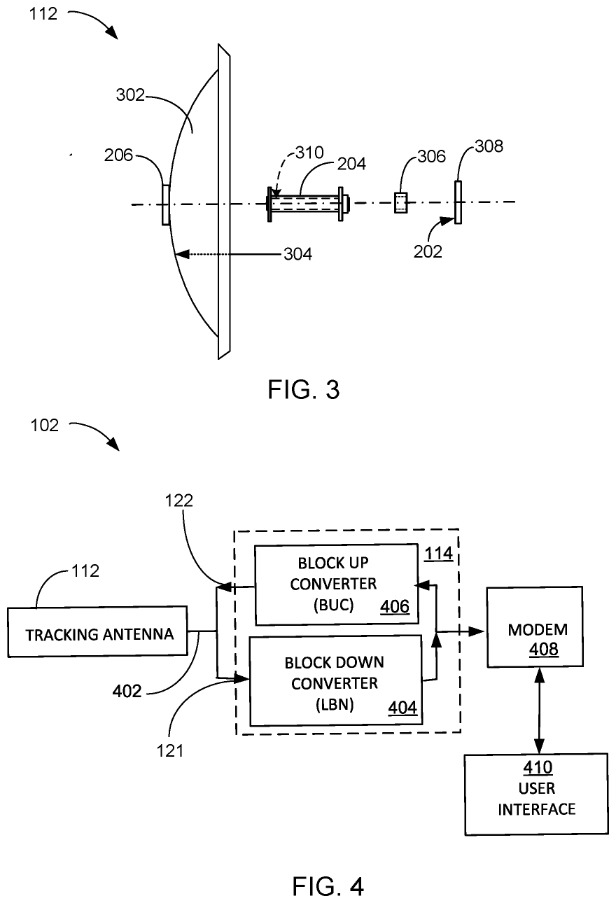

Referring now to FIG. 3, therein is shown an example of an exploded view of a Cassegrain dish tracking antenna 112 in an embodiment of the present invention. The exploded view of a Cassegrain dish tracking antenna 112 depicts a parabolic dish 302 of the tracking antenna 112 for communicating with the satellite 104 in the Ku frequency spectrum or the Ka frequency spectrum. The parabolic dish 302 can be formed of a light weight insulator material, such as s (ABS), with a concave surface 304 that is coated with Nickel (Ni). The concave surface 304 can reflect the down-link satellite packets 121 of FIG. 1 and the up-link satellite packets 122 of FIG. 1. The tracking antenna 112 can include the waveguide interface board 206, the waveguide interposer 204, that would be coupled to the parabolic dish 302, an insulation spacer 306, and a reflector 308. The waveguide interposer 204 can be formed of ABS with an inner surface 310 that can be coated with Nickel (Ni) or Copper (Cu) to form the structure of the waveguide interposer 204.

The insulation spacer 306 can fit over the end of the waveguide interposer 204 to establish the focal distance from the concave surface 304 to the reflector 308. The reflector 308 can be formed of ABS and coated with Nickel (Ni) or Copper (Cu). The parasitic layer 202 can be formed on the surface facing the concave surface 304. When assembled, the down-link satellite packets 121 and the up-link satellite packets 122 can be reflected between the concave surface 304 and the reflector 308. The parasitic layer 202 can assist in directing the down-link satellite packets 121 and the up-link satellite packets 122 through the waveguide interposer 204 to the waveguide interface board 206. By way of an example the waveguide interface board 206 can be positioned on a backside of the parabolic dish 302 in order to abut the waveguide interposer 204 through an opening in the parabolic dish 302.

The antenna control unit 110 of FIG. 1 can detect changes in the phase and signal strength of the down-link satellite packets 121 in order to make positional adjustments of the tracking antenna 112. The tracking antenna 112 can be mounted on a positional carrier (not shown) capable of maintaining the concave surface 304 of the parabolic dish 302 pointed at the satellite 104. By way of an example, the primary components of the tracking antenna 112 are made of light weight insulator material, such as ABS, in order to allow rapid repositioning between multiple of the satellite 104.

By way of an example, the parabolic dish 302 can collect the down-link satellite packets 121 and concentrate the signal at the reflector 308 in order to present as strong a signal as possible to the waveguide interface board 206. The waveguide interface board 206 can be coupled to the satellite communication circuit 114 of FIG. 1. During transmission of the up-link satellite packets 122, the satellite communication circuit 114 communicates the satellite data 119 through the waveguide interface board 206 and the waveguide interposer 204. The reflector 308 then reflects the up-link satellite packets 122 into the concave surface 304 of the parabolic dish 302, which reflects the up-link satellite packets 122 up to the satellite 104.

It has been discovered that the tracking antenna 112 can support transmitting the up-link satellite packet 122 and receiving the down-link satellite packets 121 from the satellite 104 in the LEO 103 position in both the Ku frequency spectrum and the Ka frequency spectrum without alteration. The tracking antenna 112 can be controlled by the antenna control unit 110 to provide physical positioning of the tracking antenna 112 and selective communication and tracking of the satellite 104.

Referring now to FIG. 4, therein is shown an example of a functional block diagram of the satellite interface unit 102 in an embodiment of the present invention. The functional block diagram of the satellite interface unit 102 depicts the tracking antenna 112 coupled to the satellite communication circuit 114. A coupling 402 can be through a direct connection through high frequency cable or waveguide.

By way of an example, the satellite communication circuit 114 can include a block down converter 404 and a block up converter 406. The block down converter 404 can be an analogue circuit providing a low noise block (LNB) that receives an input frequency between 10 GHz and 21 GHz and provides an output frequency between 950 and 1450 MHz. The block down converter 404 can provide a gain of 60 dB to the down-link satellite packets 121 of FIG. 1. The block up converter 406 can be an analogue circuit providing a block up converter (BUC) that receives an input signal between 950 and 1650 MHz and generates the up-link satellite packet 122 of FIG. 1 with a frequency between 10 GHz and 31 GHz. The block up converter 406 can generate an output power between 4 W and 6 W with a gain of 60 dB. The actual frequency range supported by the tracking antenna 112 can be narrower and is dependent on the band selection between a Ku band or a Ka band for communication with the satellite 104. This configuration of the tracking antenna 112 can provide additional flexibility for the transmission of the up-link satellite packet 122 and for the reception of the down-link satellite packets 121 due to the light weight and ease of positioning.

The satellite communication circuit 114 can be directly connected to a MODEM 408. The connection can be made through a common circuit board, high frequency cabling, or waveguide. The MODEM 408 can be a circuit for modulation and demodulation of the signals transferred between the satellite 104 and the satellite interface unit 102. The MODEM 408 can provide an error correction strategy that is applied to the up-link satellite packet 122 and the down-link satellite packets 121. The MODEM 408 can also provide error check and correction processes to a user interface 410. The MODEM 408 can utilize a Rees-Solomon coding, convolutional interleaving, and inner convolutional coding to protect the satellite data 119 of FIG. 1 moving through the MODEM 408.

The user interface 410 can be a multi-mode interface circuit capable of supporting cellular traffic or Internet traffic. The user interface 410 can be a hardware circuit configured to support interface specifications for cellular traffic and WiFi Internet standards. By way of an example, other interface functions can be supported by the user interface 410, including optical fiber, UHF radio transmission, VHF radio transmission, push-to-talk radio transmission, and video.

It has been discovered that the tracking antenna 112 can support transmitting the up-link satellite packet 122 and receiving the down-link satellite packets 121 from the satellite 104, in the LEO 103 position, in both the Ku frequency spectrum and the Ka frequency spectrum without alteration. The tracking antenna 112 can be controlled through the antenna control unit 110 of FIG. 1 to provide beam positioning and selective communication and tracking of the satellite 104. The communication system 100 of FIG. 1 can provide customizable local communication anywhere on the Earth that has access to the satellite 104 in the LEO 103 position.

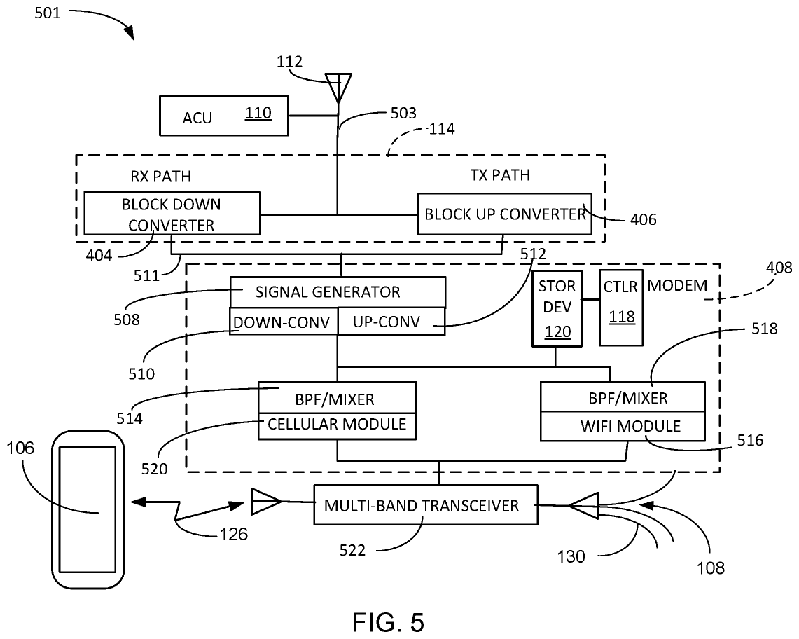

Referring now to FIG. 5, therein is shown an architectural block diagram 501 of the satellite interface unit 102 in an embodiment of the present invention. The architectural block diagram 501 of the satellite interface unit 102 depicts the tracking antenna 112 coupled to the satellite communication circuit 114 and the antenna control unit 110. The antenna control unit 110 can provide beam steering and tracking of the satellite 104 through the mechanism of the tracking antenna 112.

The satellite communication circuit 114 can include the block down converter 404 that can be in the receiver path in order to boost the received signal level without adding out of frequency noise. The satellite communication circuit 114 can also include the block up converter 406 that can boost the signal power in the transmission path to the tracking antenna 112. It is understood that in some configurations of the satellite interface unit 102, the block down converter 404 and the block up converter 406 can be integrated into the tracking antenna 112. The block down converter 404 can be an analog circuit configured to raise the signal level without introducing electrical noise into a satellite frequency 503. The block up converter 406 can be an analog circuit configured to raise the power level of an encoded signal, at the satellite frequency 503, in preparation for sending the up-link satellite packet 122 of FIG. 1 to the satellite 104 of FIG. 1. By integrating the block down converter 404 and the block up converter 406 into the tracking antenna 112, the down-link satellite packets 121 and the up-link satellite packet 122 will be less susceptible to electrical noise due to shorter transfer lengths of the unamplified signals.

The MODEM 408 can process the down-link satellite packets 121 of FIG. 1 and generate the frequency and data content for the up-link satellite packets 122. The MODEM 408 can be an application specific integrated circuit (ASIC) that includes a signal generator 508 for generating and tracking the reference frequency for encoding/decoding the data sent to or received from the satellite 104.

A low-noise block downconverter 510 can serve as the RF front end of the satellite communication circuit 114, receiving the microwave signal from the satellite 104, amplifying it, and down-converting the block of frequencies to a lower block of intermediate frequencies (IF). The low-noise block downconverter 510 can be a hardware circuit tuned for reducing the frequencies received from the satellite 104 to a more easily routable data rate frequency 511. It is understood that the data rate frequency 511 can be decades lower frequency than the satellite frequency 503.

The storage device 120 can be controlled by the unit controller 118 to capture the satellite data 119 of FIG. 1 present in the data rate frequency 511. The unit controller 118 can perform error correction, decoding and translation processes of the satellite data 119 in the MODEM 408. The unit controller 118 can also manage packet construction and error checking for other functions within the MODEM 408. It is understood that the unit controller 118 can be a microprogrammed controller or processor that supports the packet management for the down-link satellite packets 121, the up-link satellite packets 122, the cellular communication packets 126, and the WiFi packets 130.

In the transmission path, a block up-converter 512 can receive encoded messages from the storage device 120 at the data rate frequency 511 and boost the frequency of the encoded messages to the satellite frequency 503. The block up-converter 512 can be a hardware circuit capable of combining the encoded messages at the data rate frequency 511 with the reference frequency generated by the signal generator 508 to produce the encoded messages at the satellite frequency 503.

A band pass filter (BPF)/mixer 514 can condition messages that are processed by a WiFi module 516 that can support 802.11 b/g/n for providing Internet access through the WiFi hotspot 108 of FIG. 1. The BPF/mixer 514 and the WiFi module 516 are both hardware modules that work together to transfer the WiFi packets 130 of FIG. 1. An additional band pass filter (BPF)/mixer 518 can condition messages that are processed by a cellular module 520. The additional BPF/mixer 518 and the cellular module 520 are both hardware modules that work together to transfer the cellular communication packets 126 of FIG. 1. The cellular module 520 can support several communication standards including 3G, 4G, long term evolution (LTE), and 5G. It is understood that other communication standards can be implemented.

Both the WiFi module 516 and the cellular module 520 can be coupled to a multi-band transceiver 522 that can boost the power of the WiFi packets 130 and the cellular communication packets 126 for communication with external devices including the communication device 106 and the WiFi hotspot 108. The multi-band transceiver 522 can be a hardware module capable of transmitting and receiving messages at different frequencies and having different content. The multi-band transceiver 522 can provide sufficient power to broadcast the content from the WiFi module 516 and the cellular module 520. The multi-band transceiver 522 can produce the WiFi packets 130 including wireless Internet signals having a frequency of 2.4 GHz.

It is understood that the satellite interface unit 102 can include the power module 116 of FIG. 1 in order to provide the energy required to power the hardware circuits for communicating between the satellite 104, the communication device 106, the WiFi hotspot 108, and extend the battery life of the communication device 106. It is further understood that additional interface modules can be installed in order to support specific communication structures not listed above.

It has been discovered that the satellite interface unit 102 can provide a number of communication services without the use of the local infrastructure 105 that may be damaged or without the power required to operate normally. The satellite interface unit 102 provides a communication base for exchanging information between the satellite 104, the communication device 106, the WiFi hotspot 108, or a combination thereof, that can support a few people, such as first responders, aid workers, emergency medical technicians, or a small town with hundreds of people. The satellite interface unit 102 can act as a temporary base for all emergency communication to provide a WiFi zone of at least 1 km. The satellite interface unit 102 can also provide a communication structure for a residence that is off-the-grid and has no wired power available.

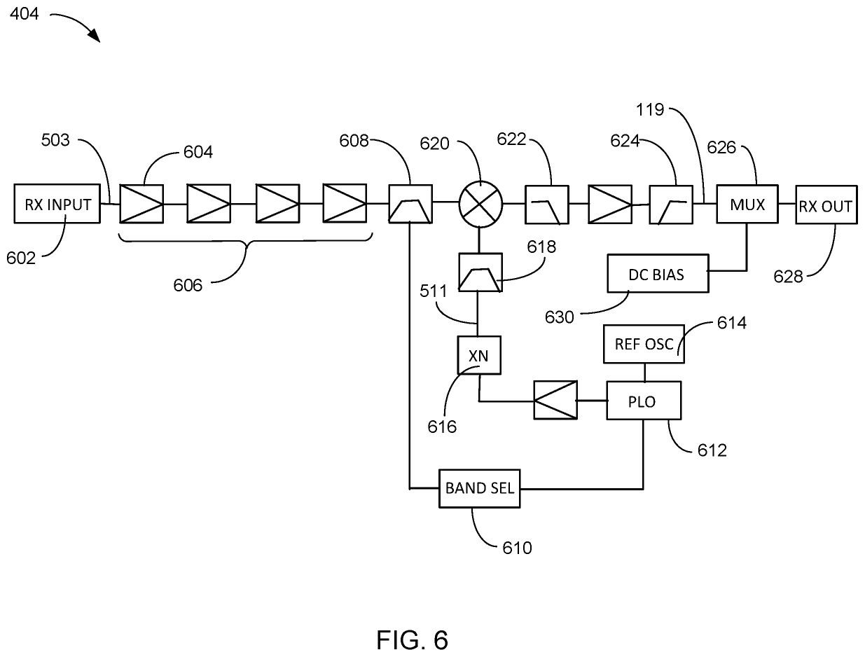

Referring now to FIG. 6, therein is shown an architectural block diagram of a low noise block down converter (LNB) 404 in an embodiment of the present invention. The architectural block diagram of a low noise block down converter (LNB) 404 depicts a receiver input block 602 that receives the down-link satellite packets 121 of FIG. 1 at the satellite frequency 503. a linear amplifier 604 can be coupled to the receiver input block 602. The linear amplifier 604 can be an analogue circuit configured to increase the amplitude of the down-link satellite packets 121 without inducing additional electrical noise in the path. The linear amplifier 604 can provide approximately 15 dB of gain at the satellite frequency 503. By way of an example the satellite frequency 503 can be 10 GHz to 13 GHz for the satellite 104 of FIG. 1 operating in the Ku band and 19 GHz to 21 GHz for the satellite 104 operating in the Ka band.

A bulk gain block 606 can be formed by a series of the linear amplifier 604 coupled output to input. By the serial connection of the linear amplifier 604, a 60 dB gain can be achieved. By way of an example, the bulk gain block 606 is shown with four of the linear amplifier 604, but it is understood that a different number of the linear amplifier 604 can be used to form the bulk gain block 606. A band pass filter 608 can be coupled to the output of the bulk gain block 606 in order to eliminate the harmonics that can be developed through the serial connection of the linear amplifier 604. The band pass filter 608 can allow frequencies in the range of 10 GHz to 13 GHz for the satellite 104 operating in the Ku band and 19 GHz to 21 GHz for the satellite 104 operating in the Ka band. A band select switch 610 can adjust the roll-off points of the band pass filter 608. By way of an example, the band select switch 610 can change the passband, such as the frequencies allowed to pass through the band pass filter 608, between the range of 10 GHz to 13 GHz for the satellite 104 operating in the Ku band and 19 GHz to 21 GHz for the satellite 104 operating in the Ka band.

The band select switch 610 can also adjust a phase-lock loop oscillator (PLO) 612. The phase-lock loop oscillator 612 can create a center frequency that can be adjusted or tracked based on a desired frequency of the block down converter 404. A reference oscillator 614 can provide a sampling frequency for the phase-lock loop oscillator 612. The reference oscillator 614 can be an analogue circuit or a crystal oscillator that establishes the sampling frequency for the phase-lock loop oscillator 612. The phase lock loop oscillator 612 can be an analogue circuit that provides the source for the data rate frequency 511.

The output of the phase-lock loop oscillator 612 can be buffered from the load of the circuit by the linear amplifier 604 coupled to the output. The linear amplifier 604 can be coupled to a frequency multiplier 616 that can be an analogue circuit that sets the frequency of the block down converter 404. It is understood that the frequency multiplier 616 can provide a fractional multiplier or an integer multiplier of the output of the linear amplifier 604. The output of the frequency multiplier 616 is a data rate frequency 511 that is a lower frequency than the satellite frequency 503. The data rate frequency 511 represents the actual rate of the satellite data 119 that is contained within the down-link satellite packets 121.

The output of the frequency multiplier 616 can couple to a second band pass filter 618 in order to remove harmonics that can be introduced by the linear amplifier 604 and the frequency multiplier 616. The band pass filter 608, passing the satellite frequency 503, can be mixed with the output of the second band pass filter 618 by a mixer circuit 620. The mixer 620 can be an analogue circuit that joins the signals from the band pass filter 608 and the second band pass filter 618. The resultant combination of the two frequencies, the satellite frequency 503 from the band pass filter 608 and the reference frequency from the second band pass filter 618 can produce lower beat frequency. A low pass filter 622 can be coupled to the mixer 620 in order to reduce aliasing in the higher frequencies. The low pass filter 622 is an analogue circuit that passes lower frequencies and rejects the higher frequencies produced by the mixer 620. the output of the low pass filter 622 can be coupled to the linear amplifier 604 in order to amplify the signal generated by the low pass filter 622.

The output of the linear amplifier 604 can represent the low and middle frequencies derived from the down-link satellite packets 121. A high pass filter 624 can remove the low frequency aliasing and harmonics from the linear amplifier 604. The high pass filter 624 can be an analogue circuit that passes middle and high frequencies and blocks any low frequencies present in the signal. The output of the high pass filter 624 can represent a lower frequency representation of the satellite data 119 within the down-link satellite packets 121. The satellite data 119 can be coupled to a multiplexer 626 that can pass the satellite data 119 as a receiver output 628 during a receiving cycle, controlled by the antenna control unit 110 of FIG. 1, or it can select a DC bias circuit 630 during the transmit cycle when the receiver output 628 is blocked. The DC bias circuit 630 can be an analogue circuit that establishes a neutral switching state to the MODEM 408 of FIG. 4.

It has been discovered that the low noise block down converter (LNB) 404 can actively support the receiving of the satellite data 119 when the satellite 104 is operating in the 10 GHz to 13 GHz for the Ku band and 19 GHz to 21 GHz for the satellite 104 operating in the Ka band. The low noise block down converter (LNB) 404 can also enter a neutral state reflected by the DC bias circuit 630 when the antenna control unit 110 is actively transmitting the up-link satellite packet 122 of FIG. 1. The low noise block down converter (LNB) 404 represents an improvement in the communication with the satellite 104 because the circuit can support the operation in the Ku band and the Ka band under control of the antenna control unit 110.

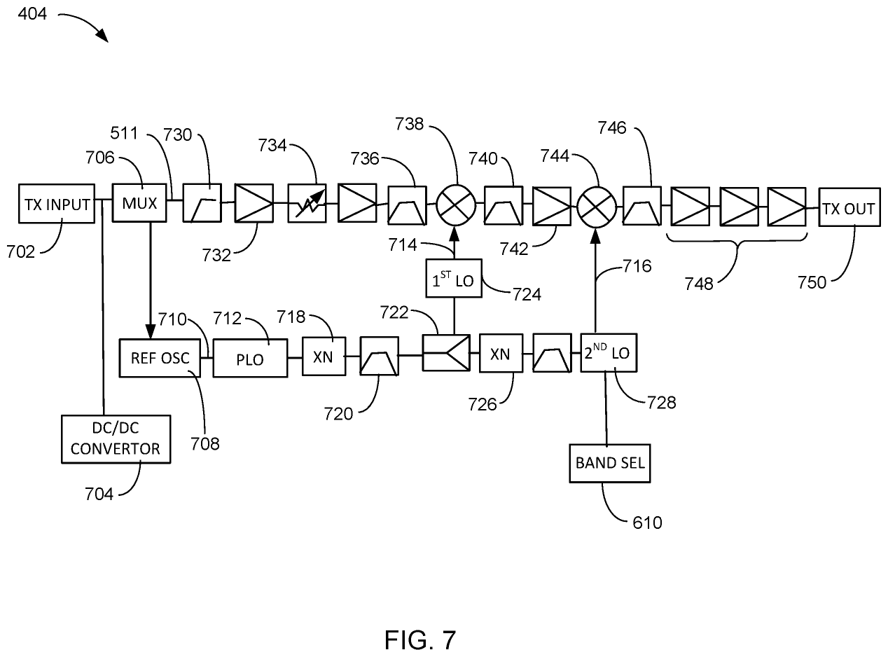

Referring now to FIG. 7, therein is shown an architectural block diagram of the block up converter (BUC) 406 in an embodiment of the present invention. The architectural block diagram of the block up converter (BUC) 406 depicts a transmit input 702 that receives the satellite data 119 of FIG. 1 in preparation for transmission to the satellite 104 of FIG. 1. The transmit input 702 can be coupled to a DC to DC converter 704 that provides a neutral termination voltage to the block up converter (BUC) 406, when the antenna control unit 110 of FIG. 1 has enabled the receive functions, and a multiplexer 706 that is controlled by the antenna control unit 110 to enable to block up converter (BUC) 406 to remain in standby during the receive functions.

During the transmit functions, the multiplexer can provide the satellite data 119 at the data rate frequency 511 and enable a reference oscillator 708 that can source a transmission reference 710. The reference oscillator 708 can be an analog circuit or a crystal oscillator that provides the transmission reference 710 to a phase lock loop oscillator 712. The phase lock loop oscillator 712 can be an analogue circuit that establishes the reference for a first transmission frequency 714 and a second transmission frequency 716. The output of the phase lock loop oscillator 712 can be coupled to a frequency multiplier 718 that can be an analogue circuit that sets the frequency reference for the first transmission frequency 714 and the second transmission frequency 716. It is understood that the frequency multiplier 718 can provide a fractional multiplier or an integer multiplier of the output of the phase lock loop oscillator 712.

The frequency multiplier 718 can be coupled to a band pass filter 720. The band pass filter 720 can be an analogue circuit that eliminates the harmonics that can be developed through the frequency multiplier 718. By way of an example, the band pass filter 720 can be configured to pass frequencies in the range of 10 GHz to 13 GHz and attenuate frequencies above and below that range. The band pass filter 720 can be coupled to a splitter 722 that is an analogue circuit that can replicate the frequencies in two different loads. The splitter 722 can be coupled to a first local oscillator 724 and a second frequency multiplier 726. The propagation of the frequencies from the splitter 722 can enable the operation of the block up converter (BUC) 406 for output in the Ku band at frequencies between 10 GHz and 13 GHz as well as the Ka band with frequencies in the range of 29 GHz to 31 GHz.

The first local oscillator 724 can be an analogue circuit that provides a highly stable frequency that is used to change the frequency of the satellite data 119 from the data frequency 511 to the first transmission frequency 714. A second output of the splitter 722 can be coupled to a second frequency multiplier 726 that can be an analogue circuit that sets the frequency reference for the second transmission frequency 716. It is understood that the second frequency multiplier 726 can provide a fractional multiplier or an integer multiplier of the output of the splitter 722. The output of the second frequency multiplier 726 can be coupled to another of the band pass filter 720 in order to pass only the frequencies in the range of 29 GHz to 31 GHz.

The output of the another band pass filter 720 can be coupled to a second local oscillator 728. The second local oscillator 728 can be can be an analogue circuit that provides a highly stable frequency that is used to change the frequency of the satellite data 119 from the first transmission frequency 714 to the second transmission frequency 716. The band select switch 610 can selectively disable the second local oscillator 728 when the Ku band communication is enabled.

The multiplexer 706 can source the satellite data 119 at the data rate frequency 511. The multiplexer 706 can be coupled to a high pass filter 730 configured to attenuate any low frequency harmonics caused by the loading of the multiplexer 706 and the DC to DC converter 704. The high pass filter 730 can be an analogue circuit that passes middle and high frequencies and blocks any low frequencies present in the signal. The output of the high pass filter 730 can be coupled to a linear amplifier 732 in order to increase the gain of the signal and restore the edge shape. The linear amplifier 732 can be an analogue circuit configured to increase the amplitude of the satellite data 119 that has passed through the high pass filter 730.

The output of the linear amplifier 732 can be coupled to a temperature variable attenuator (TVA) 734 that can adjust the phase of the bit stream in the satellite data 119. The temperature variable attenuator (TVA) 734 is an analogue circuit that can provide thermal compensation to the satellite data 119 in preparation for transmission to the satellite 104. Another of the linear amplifier 732 can be coupled to the output of the temperature variable attenuator (TVA) 734 in order to restore the gain that can be depleted by the temperature variable attenuator (TVA) 734. The output of the another of the linear amplifier 732 can be coupled to a first data band pass filter 736 that can remove any harmonics that were induced by the linear amplifier 732 and the temperature variable attenuator (TVA) 734.

A first data mixer 738 can be coupled to the output of the first data band pass filter 736 and the first local oscillator 724. The first data mixer 738 can be an analogue circuit that joins the signals from the first local oscillator 724 and the first data band pass filter 736 in order to change the frequency of the satellite data 119 to the first transmission frequency 714. By way of an example, the first transmission frequency 714 can be in the range of 12 GHz and 15 GHz. The output of the first data mixer 738 can be coupled to a second data band pass filter 740 that can attenuate any residual signals above or below the target of the first transmission frequency 714. A first transmission linear amplifier 742 can be coupled to the second data band pass filter 740 in order to boost the gain of the signal in preparation for changing the frequency of the satellite data 119 to the second transmission frequency 716 through a second data mixer 744. The second data mixer 744 is coupled to the second local oscillator 728 and the first transmission linear amplifier 742. It is understood that the band select switch 610 can disable the second local oscillator 728 if the up-link satellite packets 122 is operating in the Ku band. When the second local oscillator 728 is operating, the up-link satellite packets 122 is operating in the Ka band between 29 GHz to 31 GHz.

The second data mixer 744 can be coupled to a third data band pass filter 746 that can attenuate any of the signal harmonics above or below the range of the second transmission frequency 716. The output of the third data band pass filter 746 can be coupled to a power booster 748. The power booster 748 can be a series of the linear amplifier 732 configured to elevate the transmission power of a transmission output 750 to meet the four to six watt output power required to drive the tracking antenna 112 of FIG. 1 in communication with the satellite 104.

It has been discovered that the block up converter (BUC) 406 can generate the up-link satellite packets 122 with a four to six watt power level in the Ku band operating in the range of 12 GHz to 15 GHz or the Ka band operating in the range of 29 GHz to 31 GHz under control of the antenna control unit 110. The flexibility to transition from the Ku band to the Ka band and back allows the communication system 100 to selectively transition between any of the multiple satellites 104 available in view of the tracking antenna 112. This improvement in the satellite communication strategy can increase the efficiency and effective coverage of the communication system 100 in a dynamic orbit as the satellite 104 can transition into range and out of range. The switching to the next available of the satellite can be controlled by the antenna control unit 110 in an autonomous fashion without intervention by a user. By way of an example, when the satellite interface unit 102 of FIG. 1 loses contact with the satellite 104, operating in the Ka band that has travelled beyond the horizon, the antenna control unit 110 and can switch to a different one of the satellite 104 operating in the Ku band or the Ka band in an autonomous fashion, without user intervention.

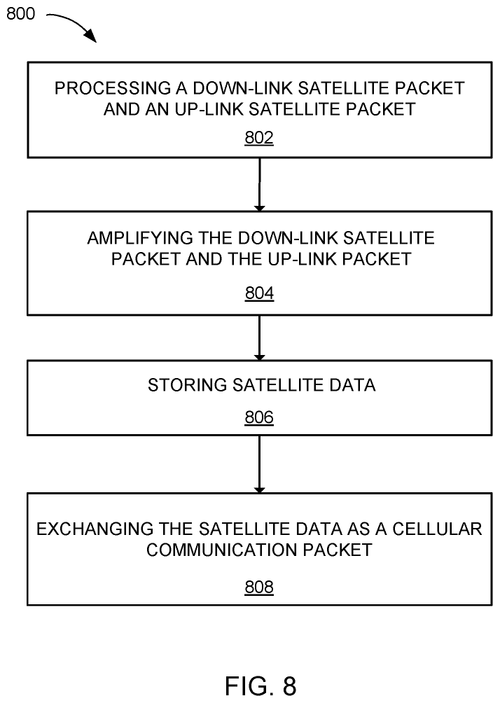

Referring now to FIG. 8, therein is shown a flow chart of a method 800 of operation of the communication system 100 in an embodiment of the present invention. The method 800 includes: processing a down-link satellite packet and an up-link satellite packet through a parasitic layer and a waveguide interposer of a tracking antenna in a block 802; amplifying the down-link satellite packet and the up-link satellite packet in a block 804; storing satellite data processed by a satellite communication circuit in a block 806; and exchanging the satellite data as a cellular communication packet, a WiFi packet, or a combination thereof when a local infrastructure is non-accessible in a block 808.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A communication system comprising:
a satellite interface unit including:
a tracking antenna configured to process a down-link satellite packet and an up-link satellite packet, wherein the tracking antenna includes a parasitic layer and a waveguide interposer,
a satellite communication circuit, coupled to the tracking antenna, configured to amplify the down-link satellite packet and the up-link satellite packet,
a storage device, coupled to the satellite communication circuit, configured to store satellite data processed by the satellite communication circuit, and
an interface module, coupled to the storage device, configured to exchange the satellite data as a cellular communication packet, a WiFi packet, or a combination thereof when a local infrastructure is non-accessible.

2. The system as claimed in claim 1, wherein the satellite communication circuit includes a block down converter and a block up converter configured to process the satellite data.

3. The system as claimed in claim 1, wherein the satellite interface unit includes an antenna control unit configured to track and selectively communicate with a satellite including switching between the satellite sending the down-link satellite packet in the frequency range of 10 GHz to 13 GHz and the satellite sending the down-link satellite packet in the frequency range of 19 GHz to 21 GHz without intervention.

4. The system as claimed in claim 1, wherein the satellite interface unit includes an antenna control unit configured to track and selectively communicate with a satellite including switching between transmitting the up-link satellite packet to the satellite at a frequency range of 12 GHz to 15 GHz and transmitting the up-link satellite packet to the satellite at a frequency range of 29 GHz and 31 GHz without intervention.

5. The system as claimed in claim 1, wherein the satellite interface unit includes an antenna control unit configured to switch between a block down converter and a block up converter.

6. The system as claimed in claim 1, wherein the satellite interface unit includes the tracking antenna controlled by an antenna control unit configured to track the satellite in Low Earth Orbit (LEO).

7. The system as claimed in claim 1, wherein the satellite interface unit includes a unit controller configured to convert satellite data into the cellular communication packet.

8. The system as claimed in claim 1, wherein the interface module configured to transfer the satellite data as the cellular communication packet includes accepting 3G, 4G, long term evolution (LTE), 5G, or a combination thereof through the cellular communication packet.

9. The system as claimed in claim 1, wherein the satellite interface unit further comprises a unit controller configured to convert the satellite data into the WiFi packet.

10. The system as claimed in claim 1, wherein the tracking antenna includes an antenna control unit configured to reposition the tracking antenna to a selected one of the satellite by physical movement of phase adjusting the tracking antenna.

11. A method of operation of a communication system comprising:
processing a down-link satellite packet and an up-link satellite packet through a parasitic layer and a waveguide interposer of a tracking antenna;
amplifying the down-link satellite packet and the up-link satellite packet;
storing satellite data processed by a satellite communication circuit; and
exchanging the satellite data as a cellular communication packet, a WiFi packet, or a combination thereof when a local infrastructure is non-accessible.

12. The method as claimed in claim 11 wherein processing the satellite data including receiving the satellite data through a block down converter and transmitting the satellite data through a block up converter.

13. The method as claimed in claim 11 further comprising communicating with a satellite by an antenna control unit coupled to the tracking antenna including switching between the satellite sending the down-link satellite packet in the frequency range of 10 GHz to 13 GHz and the satellite sending the down-link satellite packet in the frequency range of 19 GHz to 21 GHz without intervention.

14. The method as claimed in claim 11 wherein processing the up-link satellite packet includes selectively communicating with a satellite at a frequency range of 12 GHz to 15 GHz and transmitting the up-link satellite packet to the satellite at a frequency range of 29 GHz and 31 GHz without intervention.

15. The method as claimed in claim 11 further comprising switching between a block down converter and a block up converter by an antenna control unit.

16. The method as claimed in claim 11 further comprising tracking a satellite in Low Earth Orbit (LEO) includes the tracking antenna controlled by an antenna control unit.

17. The method as claimed in claim 11 further comprising converting satellite data into the cellular communication packet by a unit controller.

18. The method as claimed in claim 11 wherein transferring the satellite data as the cellular communication packet includes accepting 3G, 4G, long term evolution (LTE), 5G, or a combination thereof through the cellular communication packet.

19. The method as claimed in claim 11 further comprising converting satellite data into the WiFi packet by a unit controller.

20. The method as claimed in claim 11 further comprising repositioning the tracking antenna to a selected one of the satellite includes physical movement or phase adjusting the tracking antenna.
